(19) United States
(12) Patent Application Publication
(10) Pub. No.: US 2003/0074994 A1
(43) Pub. Date: Apr. 24, 2003

(54) Series of hypoid reducers and series of hypoid geared motors

(76) Inventors: Tetsushi Isozaki, Kurashiki-shi (JP); Yasushi Mineshima, Kurashiki-shi (JP); Masanori Egawa, Chiryu-shi (JP); Takao Shigemi, Ohbu-shi (JP); Kiyoji Minegishi, Chita-gun (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/277,086

(22) Filed: Oct. 22, 2002

(30) Foreign Application Priority Data
Oct. 22, 2001 (JP) 2001-323533

(51) Int. Cl. F16H 57/02

(52) U.S. Cl. 74/421 A; 74/606 R

(57) ABSTRACT

A series of hypoid reducers (reducing devices) and a series of hypoid geared motors are provided in a wide variety at a low cost, which corresponds to many different speed reduction ratios and a low cost inventory. The hypoid reducers have a hypoid gear set including a hypoid pinion and a hypoid gear. The hypoid gear sets can have different speed reduction ratios and can be integrated into a gearbox common to the series hypoid reducers.

### BACKGROUND OF THE INVENTION

1. Field of the Invention

The present invention relates to a hypoid reducing device used for a drive system such as a conveyer in a logistic system, and a hypoid geared motor formed by combining a motor with the hypoid reducing device.

2. Description of the Related Art

A reducing device using a hypoid gear set is used especially in fields where increasing efficiency, reducing noise, or reducing the size in the axial direction of a driven shaft is required.

A reducing device using a hypoid gear set is disclosed in U.S. Pat. No. 5,203,231 and is widely known. The purpose of this reducing device is to reduce the number of gearboxes in stock which directly lead to an increase in cost, and thereby reduce the overall cost of the manufacturing system of the reducing device while meeting a possible speed reduction ratio ranging from 1/5 to 1/240 required by users with a three-stage common (the same dimension) gearbox.

However, as the processing speed has recently increased in their major application field of transport and logistic machinery such as a conveyer, a low speed reduction ratio ranging from 1/5 to 1/20 is especially required.

While a single-stage hypoid gear set can sufficiently attain the speed reduction ratio in this range, since three-stage gearboxes are used, the number of parts increases unnecessarily, and disadvantageous situations in the cost and the size have become apparent.

In view of the foregoing, single-stage hypoid reducing devices are proposed in Japanese Patent Laid-Open Publication Nos. 2001-124155, 2001-165246, and the like.

These hypoid reducing devices are designed intending reducing the size and the weight so as to make the best use of the advantage of the single stage.

However, as a result of more careful consideration, the present inventors have gained such expertise that a best system is not always obtained in terms of reducing the cost or making delivery earlier for a maker of manufacturing and supplying the hypoid reducing devices if the one-stage hypoid reducing device is independently prepared simply intending reducing the size and the weight.

### BRIEF SUMMARY OF THE INVENTION

The present invention is devised comprehensively considering these conditions, and provides a more rational hypoid reducing device with less loss, and a hypoid geared motor (a hypoid reducing device including a motor).

The present invention solves the problems above by providing a hypoid reducing device. The hypoid reducing device includes a hypoid gear set including an input shaft on which a hypoid pinion is formed, a hypoid gear in mesh with the hypoid pinion, and an output shaft to which the hypoid gear is attached, and a gearbox for storing the hypoid gear set. At least one hypoid gear set is selected from a plurality of hypoid gear sets having different speed reduction ratios. This selected hypoid gear set can be integrated into the gearbox. The gearbox is configured to store any one of the plurality of hypoid gear sets.

With the present invention above, the hypoid reducing device, which allows users to choose a speed reduction ratio at a low cost, can be easily built.

Since not all conventional hypoid reducing devices with a single-stage structure are intended for serialization, it is necessary to entirely redesign the gearbox and the output shaft if, for example, a reducing device with a different speed reduction ratio is manufactured. This not only means that the redesign is difficult, but also means that inventory costs for individual parts increases enormously.

According to the present invention, a plurality of reducing devices sharing the same size gearboxes and output shafts, can be built which minimizes the cost of manufacture. The detail is described later.

### BRIEF DESCRIPTION OF THE DRAWINGS

FIG. 1 is a sectional view as seen from a side of a hypoid reducing device with a motor according to an embodiment of the present invention.

FIG. 2 is a sectional view as seen from a side, and showing an application form of the hypoid reducing device with a motor;

FIG. 3 is a sectional view as seen from the front of the hypoid reducing device with a motor; and

FIG. 4 is a sectional view showing examples of a series of hypoid reducing devices with motors.

### DETAILED DESCRIPTION OF THE SEVERAL VIEWS OF THE EMBODIMENTS

The following will describe an embodiment of the present invention with reference to the accompanying drawings.

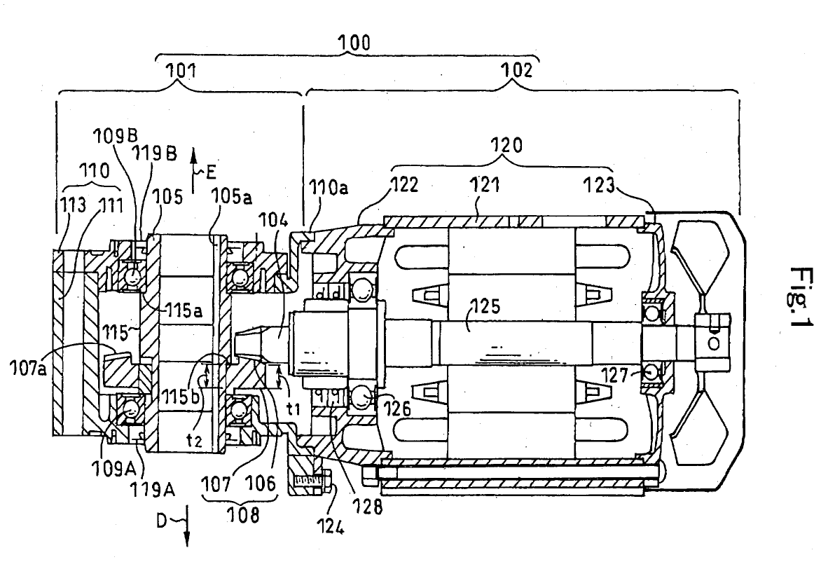

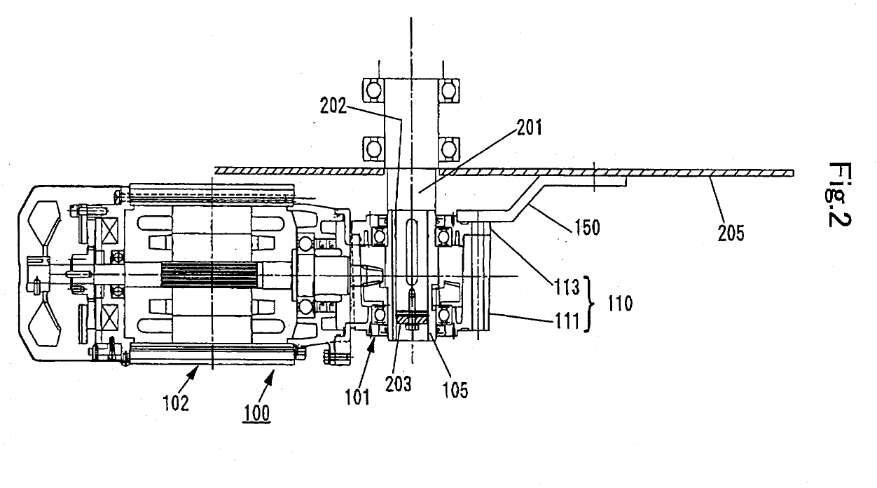

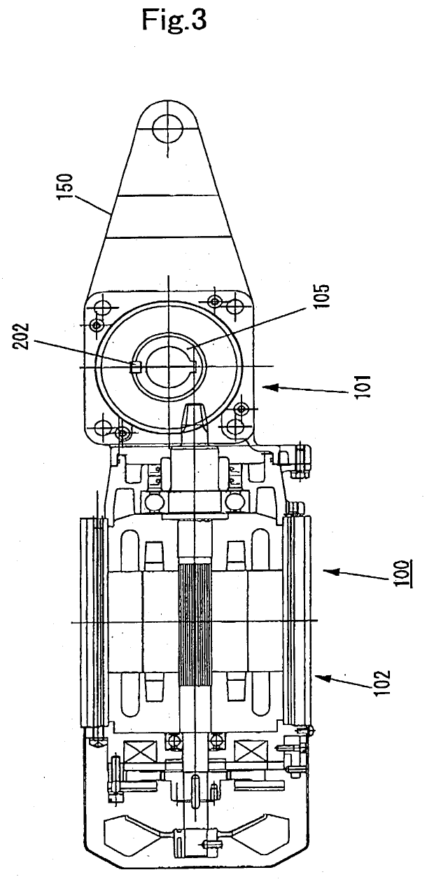

FIG. 1 is a sectional view of a hypoid reducer (a hypoid reducing device) with a motor (a hypoid geared motor) as an embodiment of the present invention, FIG. 2 is a sectional view seen from the side showing its application form, and FIG. 3 is a sectional view of the application form seen from the front.

The structure of a hypoid reducer with a motor will be detailed with reference to FIG. 1.

The hypoid reducer with a motor 100 is an integration of a hypoid-type one-stage reducer 101 and a motor 102. This reducer 101 includes a gearbox 110 as an outer shell. The motor 102 includes a motor casing 120 as an outer shell. The motor casing 120 includes a motor frame 121, a front cover 122, and a rear cover 123.

The reducer 101 and the motor 102 are securely integrated with each other by connecting the front cover 122 of the motor casing 120 and a side flange 110a of the gearbox 110 with each other by means of a bolt 124, in a spigot and a socket manner. A drive shaft 125 of the motor 102 is rotatably supported by a front bearing 126 engaged with the front cover 122 and a rear bearing 127 engaged with the rear cover 123. Thus the motor 102 can be structured so as to supply the drive shaft 125 with rotational power. A two-stage seal 128 is provided on the front side of the front bearing 126 engaged with the front cover 122 so as to prevent lubricating oil from penetrating the side of the reducer 101 into the side of the motor 102.

The reducer 101 includes an input shaft 104, an output shaft 105, a hypoid gear set 108, two bearings 109A and 109B, and the gearbox 110. The input shaft 104 can be integrated with the drive shaft 125 of the motor 102. The output shaft 105 can be formed as a hollow shaft provided orthogonal to the input shaft 104. The hypoid gear set 108 can include a hypoid pinion 106 formed on the input shaft 104, and a hypoid gear 107 formed on the output shaft 105. The two bearings 109A and 109B rotationally support the output shaft 105 on both sides of the hypoid gear 107 in the axial direction. Examples of bearing include angular ball bearings, deep groove ball bearings, and tapered roller bearings for withstanding a thrust load. The gearbox 110 engages these two bearings 109A and 109B to hold them.

The gearbox 110 includes a gearbox main body 111 including an opening in the axial direction of the output shaft 105. A gearbox cover 113 can be detachably connected with the gearbox main body 111 so as to close the opening of the gearbox main body 111 with bolts (not shown). Of the two bearings 109A and 109B supporting the output shaft 105, the first bearing 109A is engaged with the gearbox main body 111, and the second bearing 109B is engaged with the gearbox cover 113. Seals 119A and 119B are respectively provided on the outside of the individual bearings 109A and 109B. The motor 102 can be connected to a side surface of the gearbox main body 111.

A meshing surface 107a of the hypoid gear 107 corresponding to the hypoid pinion 106 faces the gearbox cover 113, and the rear of the hypoid gear 107 faces the gearbox main body 111 in this reducer 101. The rear surface of the hypoid gear 107 can be supported in the axial direction by an inner ring of the first bearing 109A engaged with the gearbox main body 111. In this configuration, the rear surface of the hypoid gear 107 may come in contact with the inner ring of the bearing 109A directly or indirectly through a spacer.

The output shaft 105 formed as a hollow shaft passes through the gearbox 110. One end of the output shaft 105 in the axial direction passes through the gearbox 110 through a through hole formed in the gearbox main body 111. The other end of the output shaft 105 passes through the gearbox 110 through a through hole formed on the gearbox cover 113. As a result, a driven shaft can be inserted and engaged on either end. Thus, a keyway 105a is provided on the inner periphery of the hollow across the entire output shaft 105.

A larger diameter portion 115 slightly larger in diameter than the portions supported by the bearings 109A and 109B is provided at a middle part of the output shaft 105 in the axial direction. A stepped portion 115a on one end of the larger diameter portion 115 abuts against the second bearing 109B engaged with the gearbox cover 113. A stepped portion 115b on the other end of the larger diameter portion 115 abuts against a surface on the side of the meshing surface 107a of the hypoid gear 107 connected with the output shaft 105 with a key.

The following will describe the operation thereof.

A thrust load generated by the hypoid gear set 108 is received through the hypoid gear 107 and the first bearing 109A by the gearbox main body 111 which has a higher stiffness than the gearbox cover 113 in this reducer 101. As a result, this reducer 101 presents high strength, withstands a large load (a large transmission torque), and produces low vibration and noise compared with a case where the thrust load is received by the gearbox cover 113 connected with bolts or the like.

When a thrust load is applied to the output shaft 105 by a driven shaft of a companion machine, and the thrust load is applied to the output shaft 105 on the side of the gearbox cover 113 as shown by an arrow D, this thrust load is transmitted to the gearbox main body 111 through the output shaft 105, the stepped portion 115b of the output shaft 105, the hypoid gear 107, and the first bearing 109A in this order, and is received by the gearbox main body 111. Thus, no influence is exerted on the meshing part of the hypoid gear set 108.

Similarly, when a thrust load is applied to the output shaft 105 on the side of the gearbox main body 111 as shown by an arrow E, this thrust load is transmitted to the gearbox cover 113 through the output shaft 105, the stepped portion 115a of the output shaft 105, and the second bearing 109B in this order, and is received by the gearbox cover 113. Thus, no influence is exerted on the meshing part of the hypoid gear set 108. Therefore high torque transmission capability can be maintained without generating an extra friction loss and the like. Namely, the reducer 101 can reduce vibration and noise compared with a conventional gearbox having the same thickness, size or bolt connection strength.

The following will describe an example of installing the hypoid reducer with a motor 100 with reference to FIG. 2.

When this hypoid reducer with a motor 100 is used, a torque arm 150 is attached to an end surface of the gearbox 110 as shown in FIG. 2 and FIG. 3. Bolts (not shown) passing from the gearbox main body 111 to the gearbox cover 113 are used for fixing the torque arm 150.

When the hypoid reducer with a motor 100 is attached to a companion machine, an end of a driven shaft 201 of the companion machine is inserted into the hollow of the output shaft 105 of the hypoid reducer with a motor 100, and a key 202 is used for a connection so as to prevent slipping. A pressing member 203 is used to fix the output shaft 105 so as to prevent travel in a slip-off direction, and then, in this state, the torque arm 150, which is attached to the gearbox 110 of the hypoid reducer with a motor 100 is fixed to a frame 205 of the companion machine, to complete the installation.

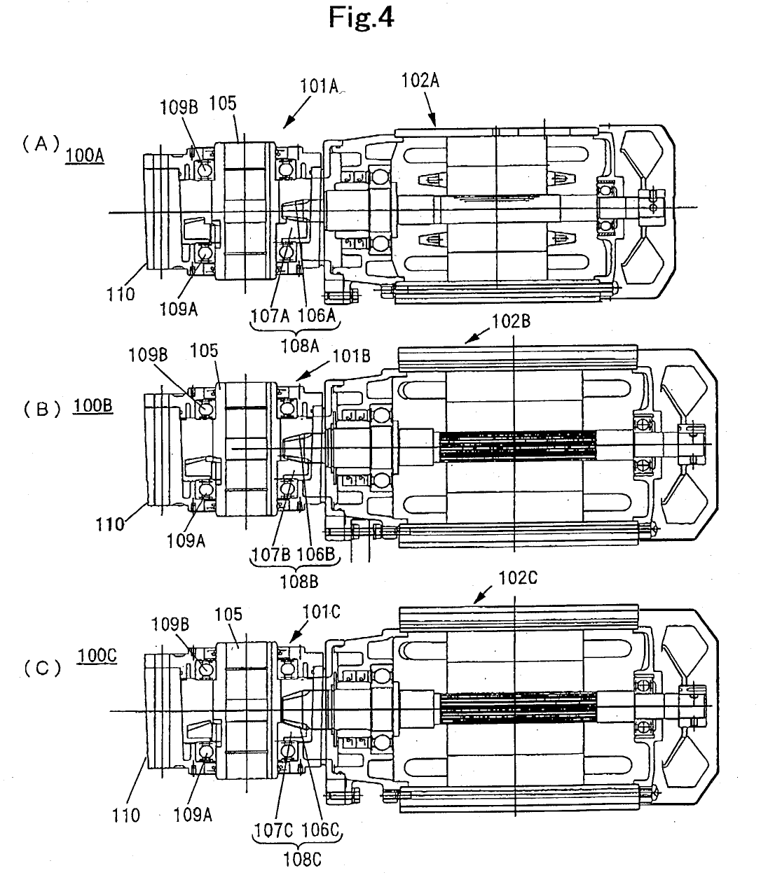

With reference to FIG. 4, the following will describe a series of hypoid reducers (reducing devices) with motors (geared motors) which allows free selection of a speed reduction ratio and a combined motor.

It is possible to prepare a reducing device without a motor as a supplied product. In addition, a series or plurality of hypoid reducing devices according to the present invention can be adopted in individual grade numbers or in a part of the individual grade numbers, and a collection of these grade numbers forms the actual entire product system. Further, it is not always necessary to prepare individual reducers and geared motors as finished products in stock. Thus, the present invention encompasses embodiments wherein a reducer or a geared motor may be manufactured or assembled after receiving an order from a user.

The term “grade number” used herein is an index for categorizing a magnitude of a supported torque (or a supported transmission capacity) when a maker supplying a series of product groups categorizes individual reducers or geared motors constituting the product groups based on the magnitude of the supported torque of the individual categories. While an interconnection dimension with respect to a companion machine is generally the same in the same grade number, there may exist a plurality of interconnection dimensions with respect to a companion machine in the same grade number. There generally exists a plurality of selectable speed reduction ratios in the same grade number.

Basically the speed reduction ratio of the hypoid gear set 108 and a combined motor can be freely selected.

However, the present embodiment also intends to reduce the cost and the inventory cost by making the size of at least a part of the gearboxes 110, uniform.

For an optimal design of the individual hypoid reducers, it is preferable that the internal space of the (single) gearbox be small in terms of the material cost, the quantity of the lubricating oil, and the like. In addition, considering that the hypoid reducer of the present invention has been independently designed so as to solve the problem of realizing a low speed reduction ratio using the conventional three-stage gearbox, it can be said that this design concept is a consequence of a natural way of thinking.

However, if this design concept were simply applied, a dedicated gearbox would be designed for every specific speed reduction ratio. Thus, this design concept is not always reasonable with respect to a manufacturing system (though this design concept is surely reasonable if only the individual reducers are considered).

In particular, the inventory cost of the gearboxes would be enormous. In terms of this point, a large gearbox with a sufficient margin may be adopted so that at least the gearbox can be used as a common gearbox for all of the hypoid gear sets. However, if the sufficiently large gearbox is simply shared, the significance of designing the new one-stage gearbox in addition to the three-stage gearboxes decreases accordingly, and simultaneously the loss increases.

Consequently, in this embodiment, the gearbox 110 can be prepared as the gearbox 110 common to the series of hypoid reducing devices. The gearbox 110 is optimally designed corresponding to the hypoid gear set 108C with the minimum speed reduction ratio (1/5 in this embodiment) in terms of at least the length of the gearbox in the axial direction of the output shaft 105 (namely, a gearbox designed considering the diameter of the hypoid pinion 106C, and the thickness of the hypoid gear 107C for realizing the minimum speed reduction ratio). When the gearbox is optimally designed based on the minimum speed reduction ratio and is designated as the common gearbox, the series can be built using the gearbox with a minimum size having the least amount of waste.

More specifically, a sectional dimension of a gearbox 110A in the output shaft direction is determined based on the outside diameter of the hypoid gear 107A of the hypoid gear set 108A with the maximum speed reduction ratio (1/10 in this embodiment). As a result, basic torque capacity of the gearbox 10 can be determined. Then, the length of the gearbox 110C in the axial direction of the output shaft 105C is determined considering the hypoid gear set 108C with the minimum speed reduction ratio (1/5 in this embodiment). Since the outside diameter of the hypoid gear 107 is determined in advance in this embodiment, the diameter of the hypoid pinion 106 increases, and consequently, a distance between the shaft center of the input shaft 104 and the meshing surface of the hypoid gear 107 increases as the speed reduction ratio is decreased in this state. In addition, since the thickness t1 (in the axial direction) of the hypoid gear 107 is set approximately two to three times the thickness of the module, the length of the gearbox 110 in the output shaft direction is determined depending on the thickness of the pinion diameter plus the thickness of the hypoid gear 107C of the hypoid gear set 108C.

Additionally, in this series, the output shaft 105 is unified in addition to the gearbox 110 so as to select and combine prescribed hypoid gear set and motor from the plurality of them.

Namely, three types of hypoid reducers with a motor shown in FIG. 4 are:

(A) A hypoid reducer with a motor 100A formed by integrally joining a motor 102A of 0.75 KW to a reducer 101A of a speed reduction ratio of 1/10 constituted by building the hypoid gear set 108A including a set of a hypoid pinion 106A and the hypoid gear 107A into the common gearbox 110, output shaft 105, and bearings 109A and 109B,

(B) A hypoid reducer with a motor 100B formed by integrally joining a motor 102B of 1.5 KW to a reducer 101B of a speed reduction ratio of 1/7 constituted by building a hypoid gear set 108B including a set of a hypoid pinion 106B and a hypoid gear 107B different from those in (A) into the common gearbox 110, output shaft 105, and bearings 109A and 109B, and

(C) A hypoid reducer with a motor 100C formed by integrally joining a motor 102C of 1.5 KW to a reducer 101C of a speed reduction ratio of 1/5 constituted by building the hypoid gear set 108C including a set of a hypoid pinion 106C and the hypoid gear 107C different from those both in (A) and (B) into the common gearbox 110, output shaft 105, and bearings 109A and 109B.

Since the gearbox 110 and the output shaft 105 are common parts in the series, the interconnection of the reducers having different speed reduction ratios 101 (101A, 101B, and 101C) with companion machines or the motors 102 (102A, 102B, and 102C) can be unified. Additionally, since the types of the parts can be reduced across the series, the inventory management can be rationalized.

The output shaft 105 (and the bearings 109A and 109B) in addition to the gearbox 110 can be unified for the reasons discussed below.

First, a difference in the position of the meshing surface due to the difference in the speed reduction ratio is adjusted by the thickness of the hypoid gear 107 in the hypoid reducer 100. Namely, the thrust load on the one side of the output shaft 105 is received by the first bearing 109A through the rear surface (the surface opposite to the meshing surface) of the hypoid gear 107, and simultaneously, the thrust load on the other side is received by the stepped portion 115a of the larger diameter portion 115 on the output shaft 105 in the hypoid reducer 100. Thus, the difference in the position of the meshing surface due to the difference in the speed reduction ratio can be adjusted by the thickness of the hypoid gear 107 (it is not always necessary to adjust by the position or the length in the axial direction of the larger diameter portion 115 of the output shaft 105). Since it is generally necessary to prepare different combinations of the hypoid gear and the hypoid pinion for realizing different speed reduction ratios, the thickness of the gear set t2 (including the thickness of a spacer if the spacer is used) is adjusted and set in advance such that a distance between the center of the pinion and the end surface of the bearing 109A is constant. As a result, it is not absolutely necessary to change the gearbox 110 and the output shaft 105 in terms of the structure. Additionally, the spacer or the like may be used for adjusting the distance while the thickness of the hypoid gear is kept constant.

Second, in the present embodiment (though basically the motor 102 combined with the reducer 101 is freely selected as long as the gearbox is common), the motor and speed reducer are combined such that the product of the speed reduction ratio of the hypoid reducer 100 and the motor capacity are equal for at least a part of the sets of the reducer 101 and the motor 102 as the example above clearly describes. Here, the speed reduction ratio refers to “nominal designation (value of denominator)”, and “10” is for “1/10” and “5” is for “1/5”.

The top hypoid reducer with a motor 100A and the bottom hypoid reducer with a motor 100C satisfy this condition among the three types of the hypoid reducers with a motor 100A to 100C in FIG. 4.

For example, “the speed reduction ratio×motor capacity”=10×0.75=7.5 for the top hypoid reducer with a motor 100A, is equal to “the speed reduction ratio×motor capacity”=5×1.5=7.5 for the bottom hypoid reducer with a motor 100C.

When the combination is restricted in this way, since the torque applied to the output shaft 105 is equalized, the output shaft is optimally designed, and simultaneously the sharing of the output shaft is promoted in terms of the strength.

The product is 7×1.5=10.5 for the remaining hypoid reducer with a motor 100B in the embodiment above. If the product (10.5 in this case) for the combination is larger than the standard product (7.5 in this case), a larger output torque is generally provided with respect to the combinations having the standard product. This combination provides a satisfactory result when it is applied to a situation where a higher output is required with the same size, or a reduced size is required for the same output.

On the contrary, if the product for a combination is smaller than the standard product, a smaller output is provided with respect to the combinations having the standard product. However, in this case, since the reducer has a “structural margin”, this combination provides a satisfactory result when it is applied to a situation where a higher durability is required such as a location where inspecting and replacing the reducer is difficult.

When the output shaft is to be shared, it is rational in different aspects that the maximum value of the product is set within a predetermined range of 2.5 or less while the minimum value of the product is 1.

While “the stepped portions of the output shaft” are directly formed on the output shaft in the embodiment described above, the outer periphery of the output shaft may have an almost constant diameter, and snap rings or the like may be used for forming stepped portions for receiving the thrust force.

With the present invention, since many different speed reduction ratios are available while the inventory cost is kept low, a series of hypoid reducers and hypoid geared motors with a wide variety are provided at a low cost.

What is claimed is:

1. A hypoid reducing device comprising:
a hypoid gear set including an input shaft on which a hypoid pinion is formed, a hypoid gear in mesh with the hypoid pinion, and an output shaft to which said hypoid gear is attached; and
a gearbox for storing the hypoid gear set,
wherein the hypoid gear set is selected from a plurality of hypoid gear sets having different speed reduction ratios, and is integrated into said gearbox, and wherein said gearbox is configured to store any one of said plurality of hypoid gear sets.

2. The hypoid reducing device according to claim 1, wherein a length of the gearbox in an axial direction of the output shaft is sized to fit the hypoid gear set, the hypoid gear set having a minimum speed reduction ratio compared to the plurality of hypoid gear sets having different speed reduction ratios.

3. The hypoid reducing device according to claim 1, wherein the hypoid reducing device is compatible with a motor providing the hypoid gear sets with power, the motor being selected from a plurality of motors having different capacities, and wherein the hypoid reducing device and motor are combined with each other such that a product of the speed reduction ratio of the hypoid gear set and a capacity of the motor is within a predetermined range.

4. The hypoid reducing device according to claim 3, wherein a maximum product of the speed reduction ratio of the selected hypoid gear set and the capacity of the selected motor is 1.0 to 2.5 times the minimum product of the speed reduction ratio of at least one remaining hypoid gear set and capacity of at least one remaining motor.

5. The hypoid reducing device according to claim 3, wherein the product of the speed reduction ratio of the selected hypoid gear set and the capacity of the selected motor is equal to the product of the speed reduction ratio of at least one remaining hypoid gear set and capacity of at least one remaining motor.

6. A hypoid geared motor comprising:
a hypoid reducer including an input shaft on which a hypoid pinion is formed, a hypoid gear in mesh with said hypoid pinion, an output shaft to which said hypoid gear is attached, and a gearbox configured to store any one of a plurality of hypoid gear sets having different speed reduction ratios; and
a motor for providing the hypoid reducer with power, the motor being connected to the hypoid reducer,
wherein at least one hypoid reducer selected from a plurality of hypoid reducers having different speed reduction ratios, and at least one motor selected from a plurality of motors having different capacities, are combined with each other such that a product of the speed reduction ratio of the at least one hypoid reducer and a capacity of the at least one motor is within a predetermined range.

7. A hypoid reducing device comprising:
transmitting means including an input shaft on which a hypoid pinion is formed, a hypoid gear in mesh with the hypoid pinion, and an output shaft to which the hypoid gear is attached; and
storing means for storing the transmitting means,
wherein the transmitting means is selected from a plurality of transmitting means having different speed reduction ratios, and is integrated into said storing means, and wherein said storing means is configured to store any one of said plurality of transmitting means.

8. The hypoid reducing device according to claim 7, wherein a length of the storing means in an axial direction of the output shaft is sized to fit the transmitting means, the transmitting means having a minimum speed reduction ratio compared to the plurality of transmitting means having different speed reduction ratios.

9. The hypoid reducing device according to claim 7, wherein the hypoid reducing device is compatible with a driving means providing the transmitting means with power, the driving means being selected from a plurality of driving means having different capacities, and wherein the hypoid reducing device and driving means are combined with each other such that a product of the speed reduction ratio of the transmitting means and a capacity of the driving means is within a predetermined range.

10. A method of manufacturing a hypoid reducing device, said method comprising the steps of:
(a) selecting a hypoid gear set from a plurality of hypoid gear sets having different speed reduction ratios, the hypoid gear set including an input shaft on which a hypoid pinion is formed, a hypoid gear in mesh with the hypoid pinion, and an output shaft to which the hypoid gear is attached;
(b) providing a gearbox configured to store any one of said plurality of hypoid gear sets having different speed reduction ratios; and
(c) integrating the hypoid gear set into the gearbox.

11. A method of manufacturing a hypoid geared motor, said method comprising the steps of:
(a) selecting a hypoid gear set from a plurality of hypoid gear sets having different speed reduction ratios, the hypoid gear set including an input shaft on which a hypoid pinion is formed, a hypoid gear in mesh with the hypoid pinion, and an output shaft to which the hypoid gear is attached;
(b) providing a gearbox configured to store any one of said plurality of hypoid gear sets having different speed reduction ratios;
(c) integrating the hypoid gear into the gearbox;
(d) meshing the hypoid pinion with the hypoid gear;
(e) coupling a motor to the hypoid gear set to provide power thereto; and
(f) connecting a motor casing to the gearbox.
